(19) United States
(12) Patent Application Publication
(10) Pub. No.: US 2026/0100088 A1
(43) Pub. Date: Apr. 9, 2026

(54) GAMING SYSTEMS WITH REFLECTIVE EMOTIVE LIGHTING ASSEMBLY

(71) Applicant: LNW Gaming, Inc., Las Vegas, NV (US)

(72) Inventors: Robert COON, Chicago, IL (US); Christian KULUJIAN, Chicago, IL (US); Alberto LOPEZ, Gurnee, IL (US); Norma RODRIGUEZ, Cicero, IL (US); Miguel A. VEGA, Chicago, IL (US)

(21) Appl. No.: 19/336,940

(22) Filed: Sep. 23, 2025

Related U.S. Application Data
(60) Provisional application No. 63/702,790, filed on Oct. 3, 2024.

(51) Int. Cl. G07F 17/32

(52) U.S. Cl. CPC G07F 17/3211; G07F 17/3216

(57) ABSTRACT

There is provided a gaming machine with an emotive lighting assembly comprising a housing assembly, a light-emitting assembly, and a reflector assembly. The housing assembly includes a transmissive window and a channel wall that at least partially defines a light channel. The light-emitting assembly includes a plurality of light-emitting devices (LEDs) secured within an internal cavity defined by the housing assembly in an orientation and configuration to emit light towards and through the transmissive window. The reflector assembly includes a reflector element aligned with the transmissive window external to the internal cavity that is oriented to guide the emitted light received through the transmissive window to the light channel, where the channel wall reflects the emitted light received from the reflector element towards an observer area associated with the gaming machine. The emotive lighting is operated via logic circuitry to present emotive lighting sequences to the observer area.

### CROSS-REFERENCE TO RELATED APPLICATIONS

This patent application claims the benefit of priority to U.S. Provisional Patent Application No. 63/702,790, filed Oct. 3, 2024, the contents of which are incorporated by reference herein in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to a technological improvement to gaming systems, gaming machines, and methods and, more particularly, to new and improved emotive lighting systems.

### BACKGROUND OF THE INVENTION

One pillar of the gaming industry is to provide a variety of gaming machines within a gaming environment, such as a casino. As the industry has matured, the gaming environments have evolved to become increasingly efficient with the floor space provided to each gaming machine, thereby creating more space to place additional gaming machines. As a result, a player visiting the gaming environment is often faced with many different gaming machines vying for his or her attention to attract the player to a gaming session. As a result, the gaming machines and underlying game content can be configured to visually stand out within a crowd of gaming machines as well as provide a cohesive presentation experience for players that do choose to initiate a gaming session at a given machine. The gaming machines may rely upon a variety of aspects to attract players, such as the shape and design of the housing, a display configuration (e.g., large displays, curved screens, touch screens, etc.), unique input means, a topper assembly above the machine, and/or emotive lighting that complements gaming content presented by the displays.

Accordingly, as the industry continues to mature, new and unique machine configurations are desired, particularly in new and unique forms of emotive lighting. Moreover, as the gaming industry is a regulated industry, various guidelines, rules, and restrictions are placed upon new machine configurations. For example, emotive lighting and displays may be subject to external sources of electrostatic discharge (ESD), such as players and other gaming machines, and various jurisdictions served by the gaming industry require at least some preventative and/or mitigation measures for a gaming machine to be approved as a regulated gaming machine. As a result, new and unique emotive lighting for a gaming machine that satisfies ESD mitigation requirements is desired.

### SUMMARY OF THE INVENTION

According to one or more embodiments of the present disclosure, a gaming machine of a gaming system includes an emotive lighting assembly comprising a housing assembly, a light-emitting assembly, and a reflector assembly. The housing assembly includes a transmissive window and a channel wall that at least partially defines a light channel. The light-emitting assembly includes a plurality of light-emitting devices (LEDs) secured within an internal cavity defined by the housing assembly in an orientation and configuration to emit light towards and through the transmissive window. The reflector assembly includes a reflector element aligned with the transmissive window external to the internal cavity that is oriented to guide the emitted light received through the transmissive window to the light channel, where the channel wall reflects the emitted light received from the reflector element towards an observer area associated with the gaming machine. The emotive lighting is operated via logic circuitry of the gaming system to present emotive lighting sequences to the observer area. The emotive lighting assembly may be combined with a display or presentation assembly and/or integrated into a topper assembly of the gaming machine.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to one or more embodiments of the present disclosure.

FIG. 2 is a block diagram of a gaming system according to one or more embodiments of the present disclosure.

FIG. 3 is a block diagram of an example gaming machine according to one or more embodiments of the present disclosure.

FIG. 4 is a cross-sectional view of an example emotive lighting assembly for a gaming machine according to one or more embodiments of the present disclosure.

FIG. 5A is a front view of an example topper assembly of a gaming machine according to one or more embodiments of the present disclosure.

FIG. 5B is a perspective view of the topper assembly shown in FIG. 5A according to one or more embodiments of the present disclosure.

FIG. 6 is a cross-sectional view of an example emotive lighting assembly for a gaming machine according to one or more embodiments of the present disclosure.

FIG. 7 is a cross-sectional view of an example emotive lighting assembly with side-facing light-emitting devices, according to one or more embodiments of the present disclosure.

FIG. 8 is a flow diagram of an example method for assembling and operating a gaming machine with an emotive lighting assembly according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

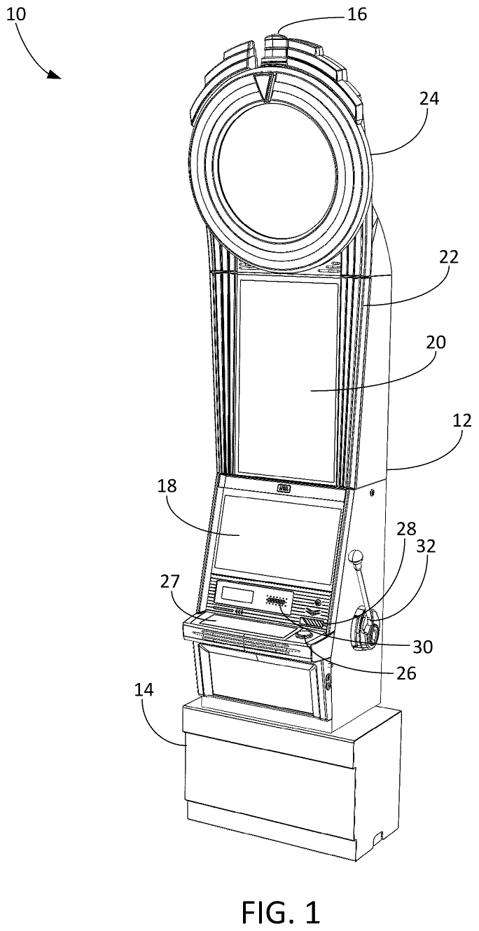

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 includes or otherwise positions upon a riser 14 that elevates the gaming machine 10 to a suitable height for player participation. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, a cabinet emotive lighting assembly 22, and a topper assembly 24. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, audio speakers, lighting assemblies (e.g., cabinet lighting assembly 22, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include one or more touch screens mounted over the primary or secondary presentation devices 18, 20, buttons 26 on a button panel (which may also include a button touch screen 27 for presenting selectable digital buttons), a bill/ticket acceptor and dispenser 28, a card reader/writer 30, a ticket dispenser, player-accessible ports (e.g., audio output jack for headphones, video headset jack, USB port, wireless transmitter/receiver, etc.), and a mechanical arm 32 for providing input to the gaming machine (e.g., input to initiate a spin of one or more reels, such as a set of mechanical symbol-bearing reels). It should be understood that numerous other peripheral devices and other elements exist and are readily utilizable in any number of combinations to create various forms of a gaming machine in accord with the present concepts.

The player input devices, such as the button 26, the touch screen 27, the arm 32 a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter, which may be presented as a graphical element on a graphical interface. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor and dispenser 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the bill/ticket dispenser 28 for printing tickets redeemable for cash or credits, a wireless communication interface for transmitting cash or credit data to a nearby mobile device, and a network interface for depositing cash or credits to a remote account via an electronic funds transfer.

In addition to the components described above, the gaming machine 10 includes the topper assembly 24 for providing additional presentation capabilities to the gaming machine 10. For example, the topper assembly 24 may be configured to present game content to a player and/or present attraction sequences to attract bystanders and other potential players to observe the gaming machine 10 and potentially initiate a new gaming session. The topper assembly 24 includes one or more presentation devices and emotive lighting assemblies to facilitate these functionalities, including those described elsewhere in detail herein. The topper assembly 24 may be coupled to the housing 12 as a whole assembly or integrated with the gaming machine 10. That is, in some embodiments, the gaming machine 10 may be configured to accept different types of topper assembly or operate without a topper assembly. It is to be understood that the term “topper” may imply a positional relationship between the cabinet 12 and the topper assembly 24, the topper assembly 24 may be positioned at any suitable position relative to the cabinet 12 to facilitate various gaming machine configurations.

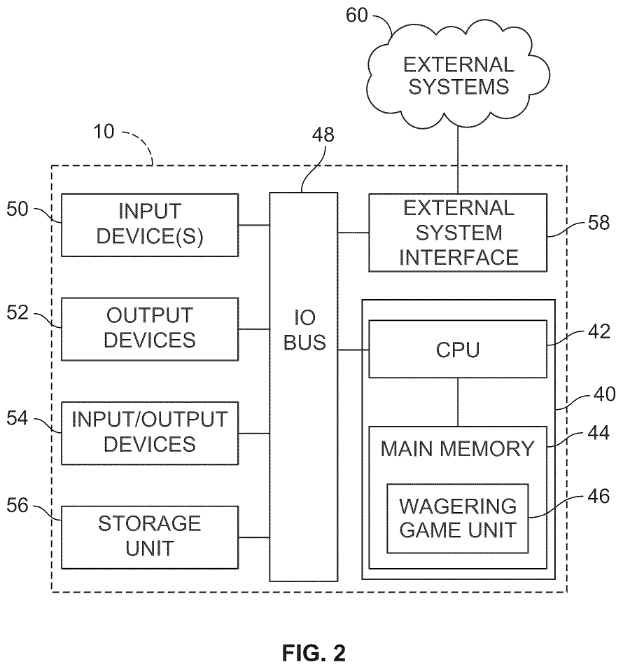

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximally to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button or physically rotating a mechanical arm of the gaming machine 10 (e.g., the arm 32, shown in FIG. 1), into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

The systems, methods, and assemblies described here facilitate new emotive lighting configurations. More specifically, a gaming machine includes an emotive lighting assembly with light-emitting devices hidden from direct view by a reflector element that facilitates guiding the emitted light into a light channel, which then reflects or otherwise guides the light out towards an area external to the gaming machine. In at least some embodiments, the light-emitting devices are protected from external sources of electrostatic discharge (ESD) by housing the light-emitting devices within an internal cavity and providing a transmissive window to facilitate the transmission of emitted light out towards the reflector element, the light channel, and, ultimately, the external area around the gaming machine. Such configuration provides a physical barrier between typical ESD sources (e.g., people and other gaming machines) and the light-emitting devices, thereby mitigating or other preventing ESD. At least some of the emotive lighting assemblies described herein are incorporated within a topper assembly that may be used to attract potential players and/or incorporate emotive lighting into game presentation sequences. It is to be understood that the emotive lighting assemblies may be included within other suitable elements and assemblies of the gaming machine, such as the primary housing of the gaming machine.

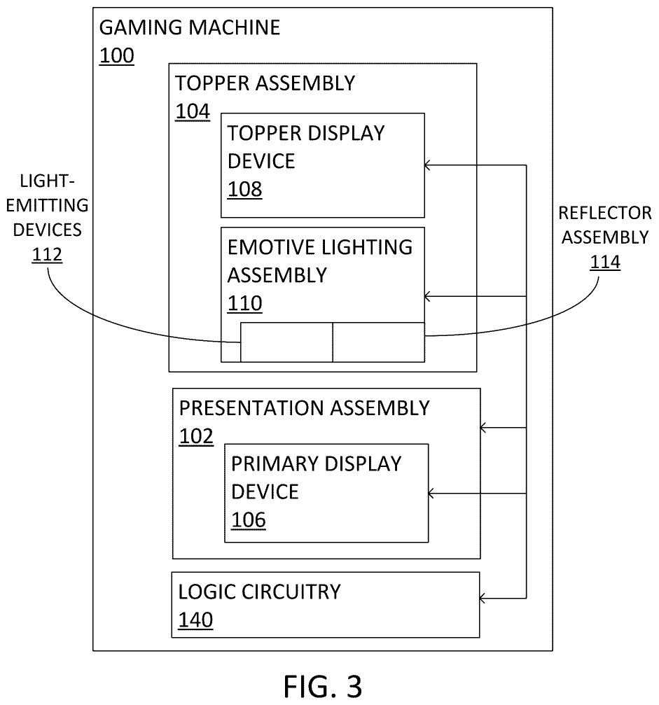

FIG. 3 is a block diagram depicting several elements of an example gaming machine 100. The gaming machine 100 may be the same as or substantially similar to the machine 10 (shown in FIGS. 1 and 2) unless otherwise noted. In the example embodiment, the machine 100 includes logic circuitry 140 in communication with a presentation assembly 102 and a topper assembly 104. The machine 100 may include additional, fewer, or alternative components, including those described elsewhere herein. For example, the machine 100 may also include various input and output devices (e.g., bill and coin acceptors, speakers, etc.) and/or additional housings that collectively form a complete housing for the gaming machine 100. In certain embodiments, one or more elements of the topper assembly 104 may be incorporated into the presentation assembly 102.

The presentation assembly 102 is configured to provide various outputs to the player for play of one or more underlying games, such as a primary display device 106. The outputs are not limited to displays, but may also include speakers, vibration motors for tactile feedback, and the like. The primary display device 106 is a primary display for presenting game content to the player. That is, the gaming machine 100 is configured to provide a position (or several positions) at which a player can sit, stand, or otherwise occupy the gaming machine 100 to initiate and participate in a gaming session. As used herein, a “player area” associated with the gaming machine 100 includes at least an area in which a player engaged at the machine 100 for a gaming session typically occupies. The player area may also include an additional area occupied by bystanders engaged with the machine 100 in contrast to, for example, bystanders that are passing by the gaming machine 100. The player area is typically in front of the gaming machine 100 and the primary display device 106 to watch the various game presentations occur.

The topper assembly 104 provides one or more presentation devices to facilitate new game presentations and/or new attraction sequences for attracting potential players to the gaming machine. The topper assembly 104 may be integrated into a housing of the gaming machine that also supports the presentation assembly 102, or the topper assembly 104 may be an independent component that is mounted to the machine 100 and connected to the machine 100 for power and/or data communication (e.g., with the logic-circuitry 140 as described herein).

In the example embodiment, the topper assembly 104 includes a topper display device 108 and an emotive lighting system or assembly 110. The topper display device 108, similar to the primary display device 106, is configured to present content associated with the underlying game or games. In certain embodiments, the topper assembly 104 includes a plurality of topper display devices 108. The emotive lighting system 110 is configured to present emotive lighting in combination with the content presented by the topper display device 108. In at least some embodiments, the emotive lighting is presented adjacent to, around, or otherwise near the topper display device 108 to facilitate a unified presentation. The emotive lighting system 110 is configured to provide emotive lighting at least partially through a reflected, diffused configuration.

In contrast to direct lighting (i.e., the light-emitting source is directly viewable by an observer), the diffused light can provide the appearance light across all or the majority of a surface rather than discrete, independent light sources. This enables the emotive lighting assembly 110 to blend light from adjacent light-emitting sources and create substantially uniform (or at least blended) light presentations to observers. This may include emotive lighting sequences that create the appearance of color animations along the viewable surface that the emitted light is directed towards.

To facilitate the reflected emotive lighting, the emotive lighting assembly 110 includes one or more light-emitting devices 112 and a reflector assembly 114. The light-emitting devices (LEDs) 112 may be light-emitting diodes or another suitable light-emitting source. The LEDs 112 are controllable to facilitate varying light outputs, such as different light intensities, colors, duty cycles, and the like. The reflector assembly 114 is configured to obscure the LEDs 112 from direct view by a player or observer within the player area or another suitable observer area of the gaming machine 100 and reflect emitted light from the LEDs 112 towards the observer area, thereby creating diffused, emotive lighting for any suitable presentation sequence of the topper assembly 104. Although such diffused lighting is described in the embodiments herein, it is to be understood that the emotive lighting assembly 110 may include additional means of emotive lighting. In certain examples, other emotive lighting outputs may harness the same LEDs 112, such as using light guides to direct a portion of the emitted light towards the reflector assembly 114 and other light guides to direct the remaining portion of the emitted light towards a different lighting output, such as a diffuser surface.

Although the embodiments herein describe the emotive lighting assembly 110 as included in the topper assembly 104, it is to be understood that the emotive lighting assembly 110 may be additionally or alternatively included in other portions of the gaming machine 100, such as the presentation assembly 102. In certain embodiments, the emotive lighting assembly 110 spans both the presentation assembly 102 and the topper assembly 104 (e.g., via the main housing of the gaming machine 100 and the housing of the topper assembly 104). The emotive lighting assembly 110 is configurable to facilitate the specific features and parameters of the installation location within the gaming machine 100 for these other embodiments.

The logic circuitry 140 is in communication with the presentation assembly 102 (including the primary presentation device 106), the topper display device 108, and the emotive lighting assembly 110 to cause the connected devices to present one or more presentation sequences of display content, emotive lighting, and/or the like. The logic circuitry 140 may include a singular processor and associated memory in communication with every device, or the logic circuitry may include a plurality of devices configured to perform the functionality of the logic circuitry as described herein. In one example, the topper assembly 104 may include dedicated logic circuitry 140 while the components of the main housing of the gaming machine 100 (including the presentation assembly 102) may have separate logic circuitry 140. In such an example, the different logic circuitries 140 may be in communication with each other to facilitate coordination and synchronization of the presentation sequence. In at least some embodiments, the logic circuitry 140 is configured to provide additional functionality beyond the presentation sequences described herein, such as conducting the underlying game and generating game content for presentation.

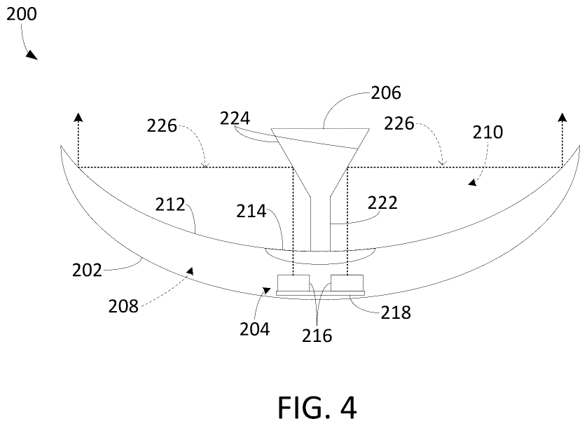

FIG. 4 depicts a cross-sectional view of an example emotive lighting assembly 200 for a gaming machine, such as the machine 10 shown in FIGS. 1 and 2 and/or the machine 100 shown in FIG. 3. The emotive lighting assembly 200 may be used in a topper assembly or another suitable emotive lighting configuration of the gaming machine. The emotive lighting assembly 200 includes a housing 202, a lighting-emitting assembly 204, and a reflector assembly 206. In other embodiments, the emotive lighting assembly 200 includes additional, fewer, or alternative components, including those described elsewhere herein.

The housing 202 is one or more structural components for securing other components together, providing structural support, providing a physical barrier between internal components and an external area around the gaming machine. The configuration (e.g., size, shape, materials, etc.) of the housing 202 is adaptable to facilitate various components and/or functions of the gaming machine, provide a particular visual profile to the gaming machine, and/or adhere to various rules, regulations, and the like of a regulated gaming machine. The housing 202 is configured to extend into various configurations for different gaming machines. For example, the housing 202 may curve to form a substantially circular profile around one or more display devices. In another example, the housing 202 extends along a side of a main cabinet of the gaming machine. The housing 202 may be integrated into or otherwise coupled with other housings to form the gaming machine.

In the example embodiment, the housing 202 defines an internal cavity 208 to house one or more components of the emotive lighting assembly 200 and/or the gaming machine. The light-emitting assembly 204 is positioned within the internal cavity 208 to mitigate potential electrostatic discharge damage to the light-emitting assembly 204 from external sources, such as players and other gaming machines. That is, the housing 202 acts as a physical barrier that provides sufficient distance between the light-emitting assembly 204 and typical external sources of electrostatic discharge faced by gaming machines to reduce or other prevent potential electrostatic discharge affecting the light-emitting assembly 204. In some embodiments, the housing 202 is grounded to facilitate routing electrostatic discharge away from electrostatic-susceptible electronic components, such as the light-emitting assembly 204, within the internal cavity 208.

In the example embodiment, the housing 202 is curved to define a light channel 210. In other embodiments, the light channel 210 may be defined in a different shape, including non-uniform shapes. The light channel 210 is at least partially exposed to an external area around the gaming machine such that one or more observers (e.g., players and bystanders) can view indirect emotive lighting from the light-emitting assembly as described herein. That is, the emotive lighting assembly 200 is configured to present emotive lighting to one or more observer areas associated with the gaming machine (e.g., a player area), and the light channel 210 is at least partially visible to the one or more observer areas to facilitate the emotive lighting presentation.

The light channel 210 is defined by one or more channel surfaces of the housing 202. In the example embodiment, the channel surface includes one or more channel walls 212 and a transmissive window 214. Although the channel surface is shown to be a smooth, curved surface, it is to be understood that the channel surface may include additional or alternative profiles and features to facilitate the functionality of the emotive lighting assembly 200 as described herein. For example, the channel walls may be slanted rather than curved, or the channel surface includes one or more features between the channel walls 212 and the transmissive window 214.

The channel walls 212 are configured to reflect emitted light from the light-emitting assembly 204 as described herein, while the transmissive window 214 is configured to facilitate transmission of emitted light from the internal cavity 208 to the light channel 210 without physically exposing the light-emitting assembly 204 to the external area. In some embodiments, the channel walls 212 and the transmissive window 214 are integrated together as a single component, but the channel walls 212 or the transmissive window 214 may be treated or otherwise altered to provide the different light characteristics. In one example, the channel walls 212 and the transmissive window 214 are made from a light transmissive material (e.g., polycarbonate), and the channel walls 212 are painted or otherwise treated to provide light-reflective characteristics along the channel surface. In other embodiments, the channel walls 212 and the transmissive window 214 are separate components coupled or bonded together to define the channel surface.

The transmissive window 214 is aligned with a point of inflection of the concave channel surface between two channel walls 212. In other embodiments, the transmissive window 214 may be positioned at a different location relative to the channel walls 212 and/or multiple transmissive windows 214 are incorporated into the channel surface. The transmissive window 214 may be a lens that focuses, guides, or otherwise alters emitted light passing through the transmissive window 214. For example, the transmissive window 214 may guide emitted light from the light-emitting assembly 204 towards the reflector assembly 206 to facilitate a particular configuration of emotive light as described herein. In other embodiments, the transmissive window 214 simply provides a passage for transmitting emitted light without substantially impeding the passing light.

The light-emitting assembly 204 includes one or more light-emitting devices (LEDs) 216 coupled to one or more lighting circuit boards 218. The LEDs 216 are a suitable light source that emits light, particularly in response to electrical current and/or lighting control data. For example, the LEDs 216 may be light-emitting diodes, organic light-emitting diodes, fluorescent lights, incandescent lights, and/or the like. The lighting circuit boards 218 secure the LEDs 216 in a particular orientation and configuration and provide electrical and/or data communication to the LEDs from one or more controllers (e.g., the logic circuitry 140, shown in FIG. 3). The lighting circuit boards 218 may further include wires and other electronic components to facilitate the functionality of the LEDs 216. For example, the lighting circuit boards 218 may include connectors for interfacing with external power sources and/or external computing devices, power conditioning circuitry, and the like. The lighting circuit board 218 may be coupled to other circuit boards 218 and/or mounting structures of the housing 202 through fasteners, wires, soldering, and/or other suitable coupling mechanisms and components.

The LEDs 216 are oriented to emit light towards and through the transmissive window 214. More specifically, in the example embodiment, the transmissive window 214 is aligned with the light-emitting assembly 204 to receive emitted light from within the internal cavity 208 and transfer the emitted light to the light channel 210. In some embodiments, the LEDs 216 are positioned proximately to or in contact with the transmissive window 214 to cause a majority of the emitted light to travel through the transmissive window 214. In other embodiments, the LEDs 216 are positioned adjacent to or in contact with one or more light guides to direct emitted light to and/or through the transmissive window 214. In further embodiments, the LEDs 216 and/or the structure of the internal housing are configured to account for lighting “losses” (i.e., emitted light that does not pass through the transmissive window 214) without the use of a light guide or reduced gap between the transmissive window 214 and the LEDs 216.

In the example embodiment, the emitted light from the LEDs 216 may pass the transmissive window 214 substantially unimpeded. In other embodiments, the transmissive window 214 may be a lens to guide the emitted light towards a particular direction or a diffuser, where the emitted light reflects within the transmissive window to blend the lighting from the transmissive window 214 over a greater surface of the transmissive window 214 than the area of the surface directly aligned with a respective LED 216.

The emitted light passing through the transmissive window 214 is then received by the reflector assembly 206. In the example embodiment, the reflector assembly 206 is aligned within the light-emitting assembly 204 and the transmissive window 214 such that a direct pathway is present for the emitted light from the LEDs 216 to the reflector assembly 206. In other embodiments, the reflector assembly 206 is not positionally aligned with the light-emitting assembly 204 and the transmissive window 214, and the reflector assembly 206 and/or another element of the emotive lighting assembly 200 includes reflectors or light guides to guide emitted light towards the reflector assembly 206.

In the example embodiment, the reflector assembly 206 includes at least a support body 222 and two reflector arms or edges 224. The support body 222 is configured to couple to the housing 202 to secure the reflector assembly 206. In some embodiments, the support body 222 is configured to segregate emitted light from different subsets of LEDs 216. For example, in the illustrated embodiment, the support body 222 is positioned between two LEDs 216 along a horizontal axis such that each LED 216 can be independently controlled without the emitted light from each LED 216 interfering with the other LED 216. This enables different colors, light intensities, and other emotive lighting control to occur throughout the emotive lighting assembly 200.

The reflector arms or edges 224 are reflective components or surfaces of the reflector assembly 206 that receive emitted light passing through the transmissive window 214 and reflect or otherwise direct the received light to the light channel 210 and, more specifically, the channel walls 212. It is to be understood that the term “reflector arm” may include surfaces of the reflector assembly 206 that are not independent extensions of the support body 222, but rather are integrated within the support body 222. In particular, the reflector arms 224 are aligned with the transmissive window 214 for receiving the emitted light and reflecting the light in a predefined manner towards the channel walls 212. The reflector arms and/or the reflector assembly 206 as a whole are formed from one or more light-reflective materials to facilitate the functionality described herein.

The channel walls 212 are configured to receive the reflected light from the reflector assembly 206 and further reflect or direct the light towards an external area associated with the gaming machine. Lines 226 are shown in FIG. 4 for an example pathway of emitted light through the emotive lighting assembly 200, though other angles of incident create various pathways for the light to travel through the assembly 200. As a result, the reflected light off the channel walls 212 is spread across the channel surface, and the curve of the channel walls 212 towards the external area provides a diffused, blended light to observers. In other words, light from one LED 216 is spread across the channel surface such that the light may overlap with the light from adjacent LEDs 216. The light radiating from the channel walls 212 is viewable by observers in expected positions relative to the gaming machine (e.g., seated in a player area, bystanders walking past the machine, etc.). The reflector assembly 206 obscures the LEDs 216 from direct view of observers in the expected positions or an expected observer area associated with the gaming machine, thereby creating an emotive lighting effect of the diffused, blended light emanating from the reflector assembly 206 along the channel walls 212.

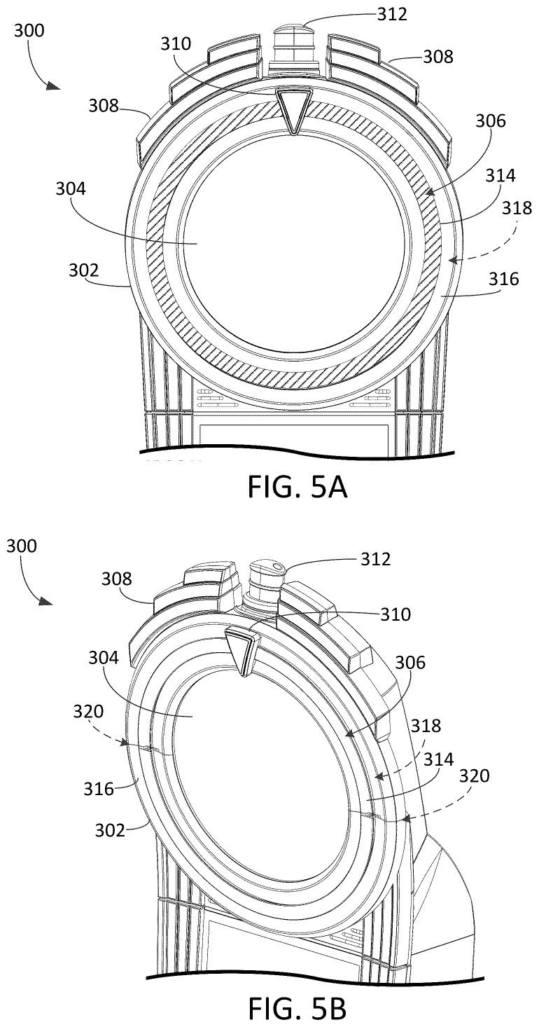

FIGS. 5A and 5B depict an example topper assembly 300 with reflective emotive lighting for use with a gaming machine, such as the machine 10 shown in FIG. 1. More specifically, FIG. 5A depicts a front view of the example topper assembly 300, and FIG. 5B depicts a perspective view of the topper assembly 300. The topper assembly 300 includes a housing 302, a topper presentation assembly 304, an emotive lighting assembly 306, ornamental shoulders 308, a pointer 310, and an indicator light 312. In other embodiments, the topper assembly 300 includes additional, fewer, or alternative components, including those described elsewhere herein.

The housing 302 is configured to secure various components of the topper assembly 300 and secure the topper assembly 300 to one or more other components of the gaming machine. In some embodiments, the housing 302 is integrated with another housing (e.g., the main cabinet 12 of the gaming machine 10, shown in FIG. 1). In other embodiments, the housing 302 and the topper assembly 300 is a separate component that is secured to one or more other housings and/or other coupling elements of the gaming machine. In certain embodiments, the topper assembly 300 is a standalone assembly that is in communication with the gaming machine, and the housing 302 is configured to mount the topper assembly 300 to a ground surface or other mounting point.

The housing 302 includes walls that define an internal cavity for securely mounting and/or housing components of the topper assembly 300. For example, the topper presentation assembly 304 and the emotive lighting assembly 306 are at least partially secured within the internal cavity. The housing 302 includes a plurality of structural elements for securing said components to the internal cavity and/or the external surface of the housing 302, such as, and without limitation, clips, brackets grooves, ledges, fastener mounting points, and the like.

The topper presentation assembly 304 (which may also be referred to as a “topper display assembly” in at least some embodiments) includes one or more display devices for presenting game content and/or other suitable content associated with the gaming machine to a player area or other suitable area associated with the gaming machine. The display devices may be electronic display devices for presenting graphical content, or the display devices may be mechanical display devices, such as a wheel that is mechanically spun (or associated with a mechanical spinning indicator). In certain embodiments, the topper presentation assembly 304 includes a hybrid configuration of electronic and mechanical display devices.

In the illustrated embodiment, the housing 302 is configured to expose the topper presentation assembly 304 in a substantially circular profile or viewport to the external area for observers to view. The topper presentation assembly 304 may be likewise substantially circular or partially obscured by the housing 302. That is, the obscured or hidden portion of the topper presentation assembly 304 may be disabled or otherwise unused for presenting game content while the exposed area of the topper presentation assembly 304 is used for presenting the game content. In other embodiments, the housing 302 and/or the topper presentation assembly 304 are configured to be a different size, shape, and/or the like according to the particular gaming machine configuration adapted by the topper assembly 300.

The emotive lighting assembly 306 is integrated within the housing 302 to provide emotive lighting adjacent to the game content presented by the topper presentation assembly 304. That is, as described herein, the emotive lighting assembly 306 includes components secured within the housing 302 for emitting light that is reflected or otherwise guided to an external surface of the housing 302 (or a suitable component coupled to the external surface of the housing 302). The light is exposed via the external surface to an external area of the gaming machine in which observers of the gaming machine may be expected, such as a player area typically occupied by a player at the gaming machine or another suitable area in which bystanders may occupy and view the gaming machine. Accordingly, the emotive lighting assembly 306 is controlled by a corresponding controller (e.g., logic circuitry of the gaming machine, such as the logic circuitries 40 and 140 shown in FIGS. 2 and 3, respectively.

The emotive lighting assembly 306 includes a reflector assembly 314, one or more channel walls 316, and one or more light channels 318. Cross-sectional lines 320 are shown in FIG. 5B to depict the depth of the emotive lighting assembly 306. In addition to the components shown in FIGS. 5A and 5B, the emotive lighting assembly 306 includes one or more light-emitting sources (not shown in FIGS. 5A and 5B) secured within the internal cavity of the housing 302 and a transmissive window or gap for passing emitted light out towards the reflector assembly 314. Further details are provided herein with respect to the internal elements of emotive lighting assemblies.

The reflector assembly 314 (shown in hatching in FIG. 5A to visually distinguish from the channel walls 516), is configured to receive emitted light from the internal light-emitting sources and reflect the emitted light to the light channel 318. The reflector assembly 314 is formed from one or more reflective materials and/or coatings for reflecting visible light. The reflector assembly 314 is positioned relative to the light-emitting sources to facilitate the intended light reflection and to obscure the light-emitting sources from direct view. By obscuring the light-emitting-sources from direct view, observers in expected or typical positions relative to the gaming machine can observe the reflected and diffused light described herein while providing a secure physical barrier between the light-emitting sources and the external area of the gaming machine. The physical barrier aids in preventing or otherwise reducing the risk of electrostatic discharge at the light-emitting sources from external sources of ESD.

In some embodiments, the reflector assembly 314 may include one or more structures for exposing light from the light-emitting sources in addition to the structure described herein. In one example, the reflector assembly 314 includes one or more integrated diffuser panels that receive a portion of the light from the light-emitting sources to present diffused light along the surface of the diffuser panels. In another example, the reflector assembly 314 includes one or more lenses or light guides to facilitate the guiding the emitted light in one or more predefined directions.

The channel walls 316 are formed from an external surface of the housing 302 and at least partially define the light channels 318 in which emitted light is reflected and guided to the external area of the gaming machine. More specifically, the channel walls 316 are curved, shaped, or otherwise positioned to receive reflected light from the reflector assembly and further reflect the light to the external area for external viewing. To an external observer, the reflected light may appear to diffuse along the surface of the channel walls 316, thereby spreading the light from a single light-emitting source over a relatively larger surface area and, in at least some embodiments, blend the light from adjacent light-emitting sources together to make the number and/or position of light-emitting sources indistinguishable to a casual observer.

In the example embodiment, the reflector assembly 314 is positioned concentrically between two channel walls 316. The emitted light is reflected from the reflector assembly 314 towards the two channel walls in opposite directions relative to the reflector assembly 314. In some embodiments, underlying light-emitting sources are divided into at least two subsets, where each subset is configured to emit light to be reflected towards one of the channel walls 316. In such an embodiment, the reflected light on either side of the reflector assembly 314 may be independently controllable to present different types of emotive lighting concurrently.

The ornamental shoulders 308 and the pointer 310 are integrated with the topper assembly 300 to provide a particular profile for the topper assembly 300. The pointer 310 may be integrated with the game content presented by the topper presentation assembly 304. For example, the topper presentation assembly 304 may be configured to present a segmented award wheel that is animated to spin and stop, where the pointer 310 provides visual indication of the selected award wheel segment when the wheel is stopped. The indicator light 312 may be similar to the light 16 shown in FIG. 1 and/or including other suitable presentation light outputs to synchronize with one or more presentation sequences incorporating the topper assembly 300.

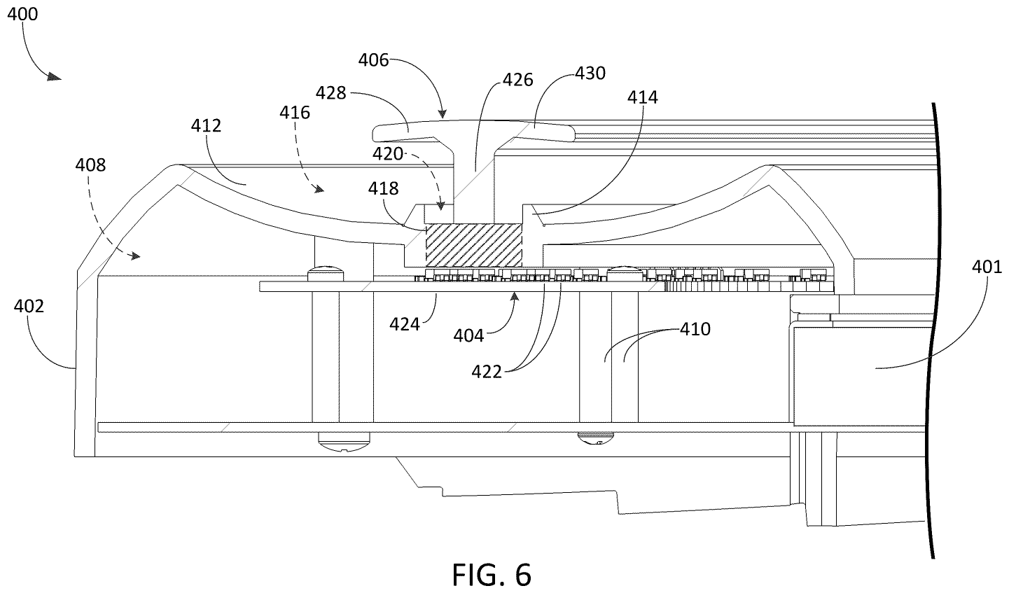

FIG. 6 depicts a cross-sectional view of an example emotive lighting assembly 400 for a gaming machine and/or topper assembly, such as the machine 10 shown in FIG. 1 and/or the topper assembly 300 shown in FIGS. 5A and 5B. For example, the cross-sectional view may be taken from the line 320 shown in FIG. 5B. In the example embodiment, the emotive lighting assembly 400 is coupled adjacent to a display device 401 that is configured to present game content. The emotive lighting assembly 400 may be configured to present emotive lighting independent of or in combination with the content presented by the display device 401 for one or more presentation sequences provided by the gaming machine. The emotive lighting assembly 400 is oriented in FIG. 6 such that the top is facing a player area or other area relative to the gaming machine for observing emotive lighting from the assembly 400. In other embodiments, the emotive lighting may be observable in additional or alternative directions relative to the assembly 400.

In the example embodiment, the emotive lighting assembly 400 includes a housing 402, a light-emitting assembly 404, and a reflector assembly 406. In other embodiments, the emotive lighting assembly 400 includes additional, fewer, or alternative components, including those described elsewhere herein.

The housing 402 is configured to secure the components of the emotive lighting assembly 400 and/or other components of the gaming machine (e.g., the display device 401). In the example embodiment, the housing 402 is formed from one or more rigid materials for providing structural support and is curved around the display device 401. That is, from the illustrated orientation of the assembly 400, the housing 402 curves from the cross-section to the right around the display device 401. In other embodiments, the housing 402 may include a different curve or other physical profile.

The housing 402 includes one or more walls and/or other physical elements that form an internal cavity 408 for housing one or more components, such as the light-emitting assembly 404. The housing 402 provides a physical barrier between the components in the internal cavity 408 and an external area surrounding the gaming machine, thereby limiting or otherwise preventing external sources of ESD, dust, and the like from impacting the internal components. It is to be understood that the cavity 408 is not limited to a single sealed interior in the embodiments of the present disclosure. Rather, the cavity 408 may be a plurality of cavities 408 and/or include one or more exposed gaps. For example, the housing 402 may include gaps for receiving and mounting other components, such as the display device 401.

The housing 402 includes one or more elements or structural components for receiving and mounting components, which may include securing subcomponents of the housing 402 together. In the example embodiment, the housing 402 includes fastener mounts 410 for securing the housing 402 together and securing the light-emitting assembly 404 in a particular position relative to the housing 402 and reflector assembly 406 as described herein.

The housing 402 includes one or more external features and/or components to facilitate emotive lighting from the light-emitting assembly 404. More specifically, in the example embodiment, the housing 402 includes a channel wall 412 and a channel ridge 414 that at least partially define a light channel 416 for observing emotive lighting from the player area or other observer area associated with the gaming machine on each side of the reflector assembly 406. In other embodiments, the housing and/or reflector assembly 314 have a different configuration relative to each other. In one example, a single light channel 416 is defined between the housing 402 and the reflector assembly 406. In another example, the housing does not include the channel ridge 414.

The channel wall 412 is curved in a concave configuration relative to the reflector assembly 406 to receive light via the reflector assembly 406 as described herein. The channel ridge 414 extends into the light channel 416 near the base of the reflector assembly 406 to obscure the light-emitting assembly 402 from direct view. Additionally or alternatively, the channel ridge 414 provides an additional surface on which emotive lighting is reflected outward to the player area. The channel wall 412 and the channel ridge 414 at least partially define a channel surface associated with the light channel 416 and are formed from one or more materials and/or coatings configured to reflect light from the light-emitting assembly 404 as described herein. The material and/or finish of the channel surface is configurable to provide a desired emotive lighting effect.

In the example embodiment, the housing 402 further includes a transmissive window 418 for transmitting or otherwise guiding emitted light from the light-emitting assembly 404 to the light channels 416. In some embodiments, the transmissive window 418 is formed from the same structure as the channel walls 412 and/or the channel ridges 414, but the window 418 has a different finish or coating to facilitate light transmission though the window 418. In other embodiments, the transmissive window 418 is a separate component coupled to the housing 402. In certain embodiments, the transmissive window 418 may be a combination of the housing 402 and one or more additional components, such as a lens assembly or light guide. In further embodiments, the emotive lighting assembly 400 does not include a transmissive window 418, but rather the housing 402 defines a gap exposing the internal cavity 408 and the light-emitting assembly 404.

The transmissive window 418 is positioned between the light-emitting assembly 404 and the reflector assembly 406. In at least some embodiments, the transmissive window 418 is aligned with the light-emitting assembly 404 and/or the reflector assembly 406 along an axis to facilitate light transmission. The transmissive window 418 is formed from a material or combination of materials in which light, particularly visible light, can pass through. In certain embodiments, the transmissive window 418 may include a lens or light guide for focusing or otherwise guiding light emitted by the light-emitting assembly to the light channels 416. In contrast to a gap exposing the light-emitting assembly 404, the transmissive window 418 facilitates light transmission while providing a physical barrier to the assembly 404, which may prevent or otherwise limit the light-emitting assembly 404 from being exposed to external sources of ESD.

In the example embodiment, light emitted by the light-emitting assembly 404 passes through the transmissive window into a reflector subchannel 420 defined within the light channel 416 between the channel ridge 414 and the reflector assembly 406. The light passing through the transmissive window 418 and the reflector subchannel 420 is received by the reflector assembly 406. The reflector assembly 406 is configured to receive the emitted light and reflect the light towards the light channel 416, particularly towards the channel wall 412.

The light-emitting assembly includes a plurality of light-emitting devices (LEDs) 422 coupled to one or more lighting circuit boards 424. The LEDs 422 are light-emitting diodes in the example embodiment. In other embodiments, other suitable types of light-emitting devices may be used. The lighting circuitry board 424 is configured to secure the LEDs 422 and any associated electronics in a predetermined configuration relative to the reset of the emotive lighting assembly 400. For example, the lighting circuit board 424 may include wires, pads, and other electrical junctions to electrically couple the LEDs 422 together and/or to other electronic devices, such as power circuitry, control circuitry, resistors, capacitors, and the like. The circuit board 424 includes one or more components to facilitate communication between a controller (e.g., logic circuitry of the gaming machine) and the LEDs 422, such as wireless antenna, wire connectors, solder joint pads, and the like. In addition to electrical components, the circuit board 424 may include one or more features or structures for physically coupling the light-emitting assembly 404 to one or more other components of the emotive lighting assembly 400. For example, the circuit board 424 may include one or more mounting holes to be aligned with one or more of the fastener mounts 410 of the housing 402 such that a fastener (e.g., screw, bolt, etc.) secured through the fastener mount 410 couples the housing 402 and the circuit board 424 together.

The circuit board 424 (or several circuit boards 424 coupled adjacent to each other) extends through the housing 402 under the light channel 416 relative to the orientation shown in FIG. 6. For example, for a substantially circular emotive lighting assembly (e.g., the assembly 306, shown in FIGS. 5A and 5B), the circuit board 424 is configured to substantially conform to the curvature of the housing 402. In other embodiments, the circuit board 424 has a different profile relative to the housing 402. For example, several rectangular circuit boards 424 may be coupled together in a circular manner within the housing 402 to approximate the curvature of the housing 402.

The LEDs 422 are arranged on the circuit board 424 to be aligned with the transmissive window 418. In the example embodiment, the LEDs 422 are arranged into two subsets of LEDs having different positions relative to the reflector assembly 406. That is, one subset is positioned on one side of the reflector assembly 406 while a second subset is positioned on the opposite side of the reflector assembly relative to an axis defined through the reflector assembly 406. In embodiments with a circular emotive lighting assembly 400, the first subset is positioned at a first radial range (i.e., one or more radial positions) relative to the origin of the circular profile of the lighting assembly 400, while the second subset is positioned at a second radial range greater than the first radial range such that the reflector assembly 406 intersects the two radial ranges. Such subset arrangement provides additional emotive lighting options as described herein. In other embodiments, the LEDs 422 may be arranged in a different configuration relative to each other and/or other components of the emotive lighting assembly 400, including configurations in which the LEDs 422 are arranged in a single group.

The reflector assembly 406 includes a support body 426, a first reflector arm 428, and a second reflector arm 430. The reflector arms 428, 430 extend outwards from the support body 426, and the support body 426 extends towards the transmissive window 418. In some embodiments, the support body 426 is positioned above the transmissive window 418. In other embodiments, the support body 426 extends into or through the transmissive window 418. In certain embodiments, the support body 426 is positioned between two transmissive windows 418. The support body 426 is coupled to the transmissive window 418 and/or the housing 402 through any suitable coupling means, such as, and without limitation, fasteners, clips, grooves, mounting brackets, adhesives, and/or combinations thereof.

The reflector assembly 406, similar to the light-emitting assembly 404, is configured to extend along the light channel 416 to facilitate the emotive lighting described herein. In some embodiments the reflector assembly 406 is uniform through the length of the light channel 416. In other embodiments, the reflector assembly 406 may be adjusted to accommodate different light channels 416 and/or provide varied emotive lighting outputs.

The support body 426 intersects between the positions of the two subsets of LEDs 422 to provide a physical barrier between the light emitted by each subset. That is, the support body 426 is aligned with an area of the light-emitting assembly 404 between the two subsets of the LEDs 422. Each of the reflector arms 428, 430 are associated with a respective subset of the LEDs 422. That is, the first reflector arm 428 is aligned with the first subset of the LEDs 422 to receive emitted light from the first subset via the transmissive window 418 and corresponding reflector subchannel 420. Likewise, the second reflector arm 430 is aligned with the second subset of the LEDs 422 to receive emitted from the second subset via the transmissive window 418 and corresponding reflector subchannel 420.

The reflector arms 428, 430 are angled, curved, or otherwise positioned to reflect the received light to the respective light channel 416, and more specifically, the respective channel wall 412. The reflector arms 428, 430 are formed from one or more materials and/or coatings that facilitate light reflection. In some embodiments, the reflector arms 428, 430 are formed from the same materials and/or coatings are the support body 426. In other embodiments, the reflector arms 428, 430 are separate components coupled to the support body 426 and/or are formed from one or more materials and/or coatings different from the support body 426 to provide the intended reflective properties. In some embodiments, the reflector assembly includes different materials, finishes, and/or coatings for reflective surfaces and surfaces not in the pathway of the light from the light-emitting assembly 404.

The reflector arms 428 extend outwards from the support body 426 is opposite directions, and therefore the reflected light is substantially guided in opposite directions towards the outer channel walls 412. Accordingly, the subsets of LEDs 422 may be separately controlled to provide different emotive lighting sequences concurrently with each other without substantially affecting the presentation of the other subset.

Reflected light received by the channel walls 412 from the reflector arms 428, 430 is, at least partially due to the curvature of the walls 412 and the angle of incidence of the reflected light, directed at an external observer area associated with the gaming machine, such as a player area in which a player at the gaming machine is typically expected to occupy. The various angles of the reflected light resulting from the angles and curves of the channel surface (e.g., the walls 412 and the channel ridges 414) and the reflector assembly 406 cause the observable light to appear diffused, where light from adjacent LEDs 422 within a given subset blend together.

In addition to facilitating the diffused, blended emotive lighting from the light channel 416, the reflector assembly 406 is configured to obscure the light-emitting assembly 404 from direct view by observers such that the emotive lighting observed from the light channel 416 appears to extend outwards from behind the reflector assembly 406. The channel ridges 414 may also provide an additional barrier to prevent direct view of the light-emitting assembly 404 from the player or observer area. Accordingly, the configuration of the housing 402, the light-emitting assembly 404, and the reflector assembly 406 provide a unique emotive lighting configuration while also providing ESD protection to the light-emitting assembly 404.

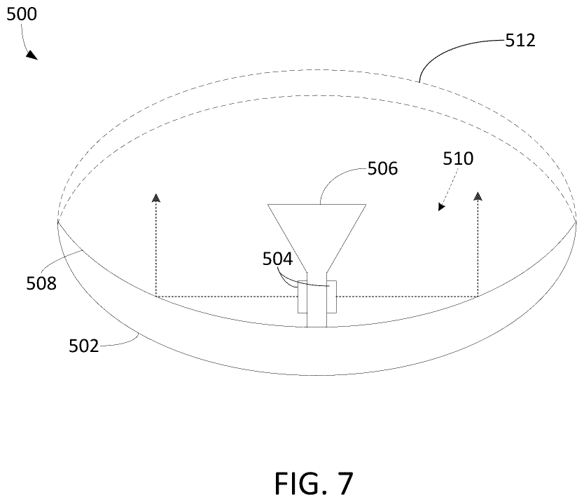

FIG. 7 depicts a cross-sectional view of another example emotive lighting assembly 500 for presenting emotive lighting on a gaming machine. The emotive lighting assembly 500 may be the same as or substantially similar to the assembly 400 shown in FIG. 6 unless described as otherwise below. In the example embodiment, the assembly 500 includes a housing 502, a plurality of light-emitting devices 504, and a reflector assembly 506. The housing 502 includes one or more channel walls 508 that at least partially define one or more light channels 510.

In the example embodiment, the light-emitting devices 504 are exposed to the light channel 510 directly and are coupled to the reflector assembly 506. The light-emitting devices 504 are oriented to emit light outward from the reflector assembly 506 towards the channel walls 508 while the reflector assembly 506 obscures the light-emitting device 504 from direct view from an external area of the gaming machine and reflects light bouncing off the walls 508 back to the light channel 510. In other embodiments, the light-emitting devices 504 may be in a different position and orientation. For example, the light-emitting devices 504 may be embedded into the channel walls 508 and oriented to emit light towards the reflector assembly 506.

In the example embodiment, the emotive lighting assembly 500 includes a transmissive barrier 512 for encapsulating the light channel 510. Similar to the transmissive window 418 shown in FIG. 6, the transmissive barrier 512 facilitates transmission of light (in this embodiment, transmission of the reflected light from the channel walls 508 to an external observer area) while providing a physical barrier between the light-emitting devices 504 and an external area in which external ESD sources may be present. In other embodiments, the emotive lighting assembly 500 does not include the transmissive barrier 512. In such embodiments, the emotive lighting assembly 500 may be positioned relative to the external area near the gaming machine and/or relative to other ESD-preventative components of the gaming machine to facilitate the ESD protection provided by the barrier 512.

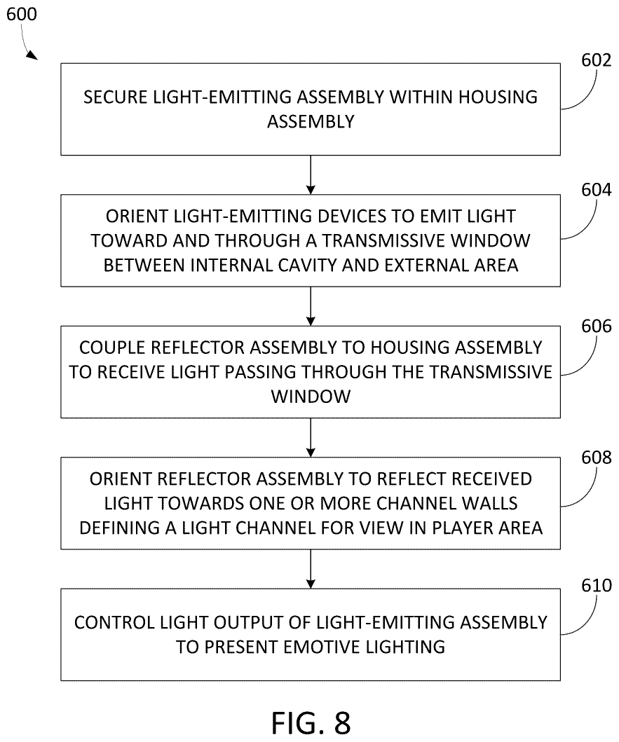

FIG. 8 depicts an example assembly and operation method 600 for an emotive lighting assembly of a gaming machine. The emotive lighting assembly associated with the method 600 may be assembled into a topper assembly of a gaming machine or another structure of the gaming machine, including the main cabinet of the gaming machine. In some embodiments, the method 600 is used for gaming machines similar to the machine 10 shown in FIG. 1. The method 600 may include operating logic circuitry associated with the gaming machine to provide one or more functions, such as causing one or more presentation sequences including emotive lighting and/or game content to be presented by the gaming machine.

The method 600 begins with securing a light-emitting assembly within a corresponding housing assembly at step 602. The light-emitting assembly includes one or more light-emitting devices for presenting controllable emotive lighting. The light-emitting assembly, with the gaming machine assembled and in normal operating condition, is in data and/or power communication with logic circuitry of the gaming machine for presenting particular emotive lighting sequences. The light-emitting assembly is secured within the housing assembly to provide a physical barrier between the light-emitting assembly and external sources of ESD that may damage the light-emitting assembly. At step 604, the light-emitting devices of the light-emitting assembly are oriented to emit light toward and through a transmissive window of the housing assembly. More specifically, the light-emitting assembly is secured in an internal cavity of the housing assembly such that the light-emitting devices are oriented to emit light at the transmissive window. The transmissive window is formed from a material or combination of materials that facilitates the transmission of visible light. Accordingly, the light emitted at the transmissive window travels from the internal cavity to an external area of the housing assembly. In the example embodiment, the external area of the housing assembly is a light channel for observing emotive lighting as described herein.

At step 606, a reflector assembly of the emotive lighting assembly is coupled to the housing assembly to receive the light passing through the transmissive window from the light-emitting assembly. In at least some embodiments, the reflector assembly, transmissive window, and the light-emitting assembly are substantially aligned along an axis to facilitate direct light travel from the light-emitting assembly to the reflector assembly. The reflector assembly is configured to reflect light received from the light-emitting assembly. More specifically, at step 608, the reflector assembly is oriented to reflect light received from the light-emitting assembly via the transmissive window towards one or more channel walls at least partially defining the light channel(s). The channel walls are viewable from an intended observer area associated with the gaming machine including the emotive lighting assembly, such as a player area in which a player is typically expected to be located when participating in a gaming session at the gaming machine. As a result of steps 602-608, light emitted by the light-emitting assembly is eventually viewable along the channel walls of the light channel(s), thereby creating a diffused, blended emotive lighting presentation. At step 610, logic circuitry in communication with the light-emitting assembly causes the assembly to emit controllable emotive lighting, which may be combined with other presentation outputs to form one or more presentation sequences associated with one or more games of the gaming machine.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a display assembly for presenting content associated with one or more games to an observer area external to the gaming machine;
a housing assembly coupled to the display assembly, the housing assembly including a channel wall and a transmissive window, wherein the channel wall at least partially defines a light channel;
a light-emitting assembly including a plurality of light-emitting devices (LEDs) secured within an internal cavity defined by the housing assembly, the plurality of LEDs oriented and configured to emit light towards and through the transmissive window;
a reflector assembly including a reflector element aligned with the transmissive window external to the internal cavity, the reflector element oriented to guide the emitted light received through the transmissive window to the light channel, wherein the channel wall is configured to reflect the emitted light received from the reflector element towards the observer area; and
logic-circuitry configured to present game content via the display assembly and emotive lighting via the light-emitting assembly for the one or more games to the observer area.

2. The gaming machine of claim 1, wherein the light channel of the housing assembly includes a channel surface comprising at least the channel wall and the transmissive window.

3. The gaming machine of claim 1, wherein the reflector assembly obscures the plurality of LEDs from direct view from the observer area.

4. The gaming machine of claim 1, wherein the reflector element includes a support body and at least one reflector arm configured to direct the emitted light from the plurality of LEDs towards the channel wall.

5. The gaming machine of claim 4, wherein the plurality of LEDs are arranged into a first LED subset and a second LED subset, and wherein the support body of the reflector element is aligned over an area of the light-emitting assembly between the first LED subset and the second LED subset, the reflector element including a first reflector arm and a second reflector arm of the at least one reflector to guide emitted light from the first LED subset via the first reflector arm and to guide emitted light from the second LED subset via the second reflector arm.

6. The gaming machine of claim 5, wherein the first reflector arm guides the emitted light in a first direction relative to the support body and the second reflector arm guides the emitted light in a second direction relative to the support body, the second direction being opposite the first direction.

7. The gaming machine of claim 1, wherein the housing assembly includes a channel ridge positioned between the channel wall and the transmissive window, the channel ridge extending into the light channel.

8. An emotive lighting system for a gaming machine comprising:
a housing assembly coupled to a display assembly for presenting content associated with one or more games to an observer area external to the gaming machine, the housing assembly including a channel wall and a transmissive window, wherein the channel wall at least partially defines a light channel;
a light-emitting assembly including a plurality of light-emitting devices (LEDs) secured within an internal cavity defined by the housing assembly, the plurality of LEDs oriented and configured to emit light towards and through the transmissive window; and
a reflector assembly including a reflector element aligned with the transmissive window external to the internal cavity, the reflector element oriented to guide the emitted light received through the transmissive window to the light channel, wherein the channel wall is configured to reflect the emitted light received from the reflector element towards the observer area.

9. The emotive lighting system of claim 8, wherein the light channel of the housing assembly includes a channel surface comprising at least the channel wall and the transmissive window.

10. The emotive lighting system of claim 8, wherein the reflector assembly obscures the plurality of LEDs from direct view from the observer area.

11. The emotive lighting system of claim 8, wherein the reflector element includes a support body and at least one reflector arm configured to direct the emitted light from the plurality of LEDs towards the channel wall.

12. The emotive lighting system of claim 11, wherein the plurality of LEDs are arranged into a first LED subset and a second LED subset, and wherein the support body of the reflector element is aligned over an area of the light-emitting assembly between the first LED subset and the second LED subset, the reflector element including a first reflector arm and a second reflector arm of the at least one reflector to guide emitted light from the first LED subset via the first reflector arm and to guide emitted light from the second LED subset via the second reflector arm.

13. The emotive lighting system of claim 12, wherein the first reflector arm guides the emitted light in a first direction relative to the support body and the second reflector arm guides the emitted light in a second direction relative to the support body, the second direction being opposite the first direction.

14. The emotive lighting system of claim 8, wherein the housing assembly includes a channel ridge positioned between the channel wall and the transmissive window, the channel ridge extending into the light channel.

15. A topper assembly for a gaming machine comprising:
a display assembly for presenting content associated with one or more games to an observer area external to the gaming machine;
a housing assembly coupled to the display assembly, the housing assembly including a channel wall and a transmissive window, wherein the channel wall at least partially defines a light channel;
a light-emitting assembly including a plurality of light-emitting devices (LEDs) secured within an internal cavity defined by the housing assembly, the plurality of LEDs oriented and configured to emit light towards and through the transmissive window; and
a reflector assembly including a reflector element aligned with the transmissive window external to the internal cavity, the reflector element oriented to guide the emitted light received through the transmissive window to the light channel, wherein the channel wall is configured to reflect the emitted light received from the reflector element towards the observer area.

16. The topper assembly of claim 15, wherein the topper assembly is coupled to a primary housing of the gaming machine above a primary display secured by the primary housing, the primary display configured to present primary game content for the one or more games.

17. The topper assembly of claim 15, wherein the housing assembly is coupled to a topper display of the display assembly, wherein the housing assembly is curved around the topper display to define a substantially circular viewport for viewing the topper display from the observer area.

18. The topper assembly of claim 15 further comprising logic circuitry in communication with the display assembly to present game content and the light-emitting assembly to present emotive lighting, the logic circuitry in communication with primary logic circuitry of the gaming machine to synchronize the game content and the emotive lighting to primary game content.

19. The topper assembly of claim 15, wherein the reflector element includes a support body and at least one reflector arm configured to direct the emitted light from the plurality of LEDs towards the channel wall.

20. The topper assembly of claim 19, wherein the plurality of LEDs are arranged into a first LED subset and a second LED subset, and wherein the support body of the reflector element is aligned over an area of the light-emitting assembly between the first LED subset and the second LED subset, the reflector element including a first reflector arm and a second reflector arm of the at least one reflector to guide emitted light from the first LED subset via the first reflector arm and to guide emitted light from the second LED subset via the second reflector arm.
